(19) United States
(12) Patent Application Publication
(10) Pub. No.: US 2014/0013214 A1
(43) Pub. Date: Jan. 9, 2014

(54) Method and System of Populating a Space

(71) Applicants: Andrew Hunter, Bristol (GB); Darryl Greig, Bristol (GB)

(72) Inventors: Andrew Hunter, Bristol (GB); Darryl Greig, Bristol (GB)

(21) Appl. No.: 13/540,820

(22) Filed: Jul. 3, 2012

(51) Int. Cl. G06F 17/00

(52) U.S. Cl. 715/246

(57) ABSTRACT

The present invention relates to a method of populating a space 10 with a plurality of child elements 12 at least one of which having variable size or shape, the method comprising: determining for each child element a permissible range of internal layouts 28 dependent on the content of the child element; generating a first set of allocations 64a, 64b, 64n of the child elements in the space, each first allocation being a layout of child elements which occupies less than the total amount of space to be populated; generating a second set of allocations 68a, 68b, 68n of the child elements by expanding the child elements allocated in each of the first allocations within the permissible range of internal layouts of the child elements such that at least some of the child elements occupy a greater amount of space in the second allocation than the first allocation.

### FIELD OF INVENTION The present invention relates generally to a method and system of populating a space.

### BACKGROUND OF INVENTION

Automatic layout algorithms simplify the composition of image-rich documents, but they still require users to have sufficient artistry to supply well cropped and composed imagery. There is an increasing need to enable users that are not skilled at populating a document to generate a composition in which the content is laid out well and is aesthetically pleasing.

An example of a space to be populated is a page of a newsletter. The content with which the page has to be populated may include textual subject-matter, photographs, and graphics. A user may have a particular layout of the content in mind and can with known systems select a document template that closely matches the intended layout and can allocate the content to the template. A problem with this relatively simple system is that a template imposes constraints on where the content can be placed and what size region in the template is available for the content. Therefore, the user is required to edit the content to fit within the space even though an allocated space is not necessarily an appropriate size to display the subject-matter of the content. This known approach focuses on the final layout of the document with little regard for the subject-matter of the content.

Another approach focuses on the subject-matter of the content and edits or crops the content so as to display the subject-matter in the best way. The edited content is then allocated to a space. The problem with this approach is that the space has a defined size and shape and it may not be possible to arrange the content so that the layout is aesthetically pleasing, for example without leaving unsightly blank regions of the space.

The present invention seeks to provide an improved method and system of populating space.

### SUMMARY OF INVENTION

The present invention provides a method of populating a space with a plurality of child elements at least one of which having variable size or shape, the method comprising: determining for each child element a permissible range of internal layouts dependent on the content of the child element; generating a first set of allocations of the child elements in the space, each first allocation being a layout of child elements which occupies less than the total amount of space to be populated; generating a second set of allocations of the child elements by expanding the child elements allocated in each of the first allocations within the permissible range of internal layouts of the child elements such that at least some of the child elements occupy a greater amount of space in the second allocation than the first allocation.

The present invention also provides a computer usable storage medium having instructions embodied therein that when executed cause a computer system to perform a method of populating a space with a plurality of child elements having variable size or shape, the method comprising: determining for each child element a permissible range of internal layouts dependent on the content of the child element; generating a first set of allocations of the child elements in the space, each first allocation being a layout of child elements which occupies less than the total amount of space to be populated; generating a second set of allocations of the child elements by expanding the child elements allocated in each of the first allocations within the permissible range of internal layouts of the child elements such that the child elements occupy a greater amount of space in the second allocation than the first allocation.

Other preferred and/or optional features of the invention are defined in the accompanying claims.

### BRIEF DESCRIPTION OF DRAWINGS

In order that the present invention may be well understood, an embodiment thereof, which is given by way of example only, will now be described with reference to the accompanying drawings, in which:

FIG. 1 shows a method of populating a space with child elements;

FIGS. 2A to 20 show four different child elements;

FIG. 3 shows a first allocation of child elements to a space; and

FIG. 4 shows a second allocation of child elements to a space.

### DETAILED DESCRIPTION OF EMBODIMENT

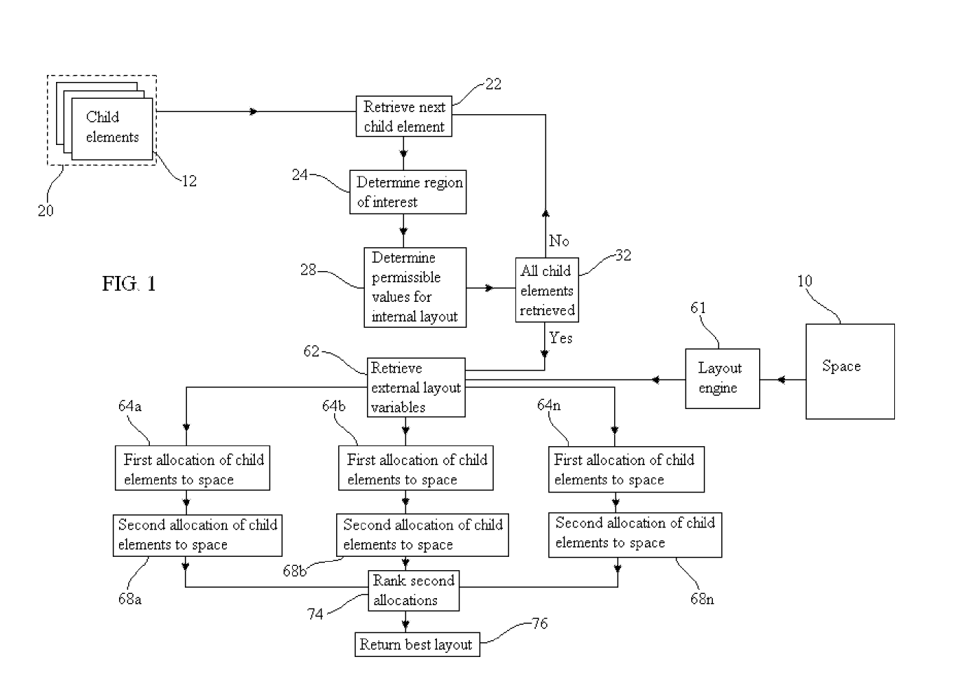

Referring to FIGS. 1 to 4, a method is described of populating a space 10 with a plurality of child elements 12 at least one of which having variable size or shape. For simplicity in the embodiment shown the child elements are images and the space is a single page. The term ‘child element’ is not restricted and can include other leaf node elements such as text, graphics or subgroups of more than one element. The term space is also not restricted and can include other spaces in which child elements are to be populated such as regions of pages, multi-page documents, brochures, albums, or posters.

The illustrated embodiment allocates dimensions and locations to each of the child elements to generate a resulting layout which meets desired design characteristics. An example of such a characteristic is the extent to which the resultant layout fills the space available for population. An alternative characteristic may be an index of composition balance, or other such index.

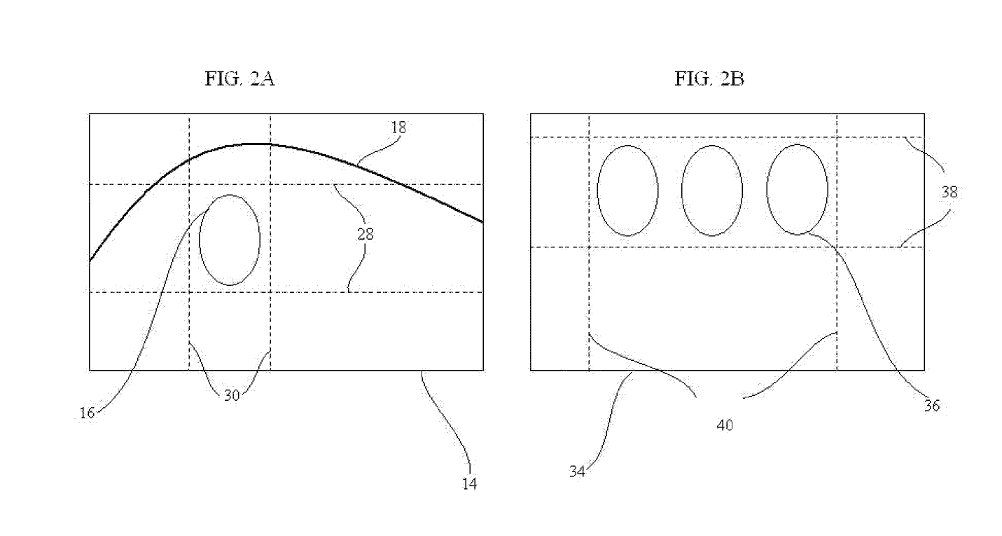

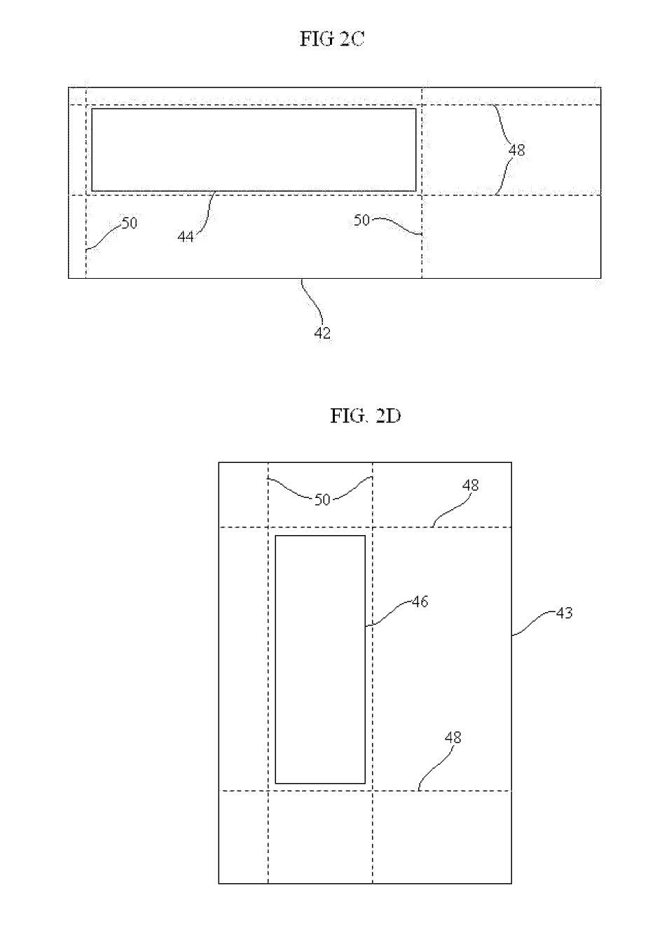

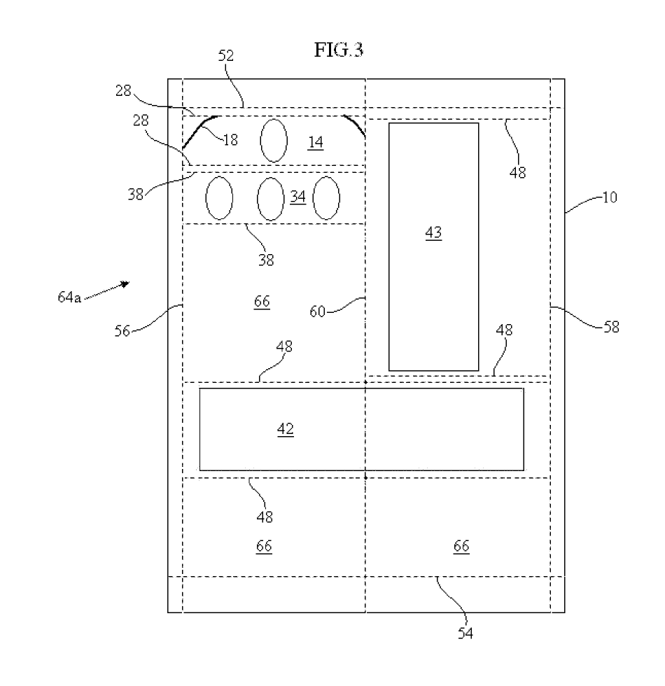

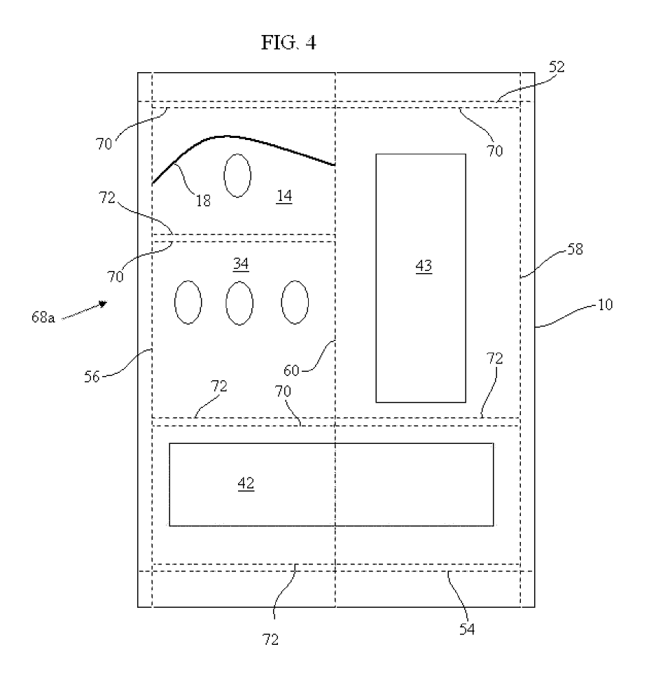

Four child elements are shown in FIGS. 2A to 2D for populating a space shown in FIGS. 3 and 4. FIG. 2A shows a first child element 14 which is an image showing a single face 16. The background 18 of the image is shown in FIG. 2A for explanatory purposes but is omitted in FIGS. 2B to 2D. The background 18 is a hill located behind the person in the image.

In the method, the first child element 14 is retrieved at step 22 from a store 20 of child elements. A region of interest (ROI) is determined at step 24 for the child element 14 and in this example face detection supplies the ROI 16, ignoring background 18. A face detection algorithm is run over the retrieved image to determine the location of all faces in all orientations, and the combination of all the face locations is taken to be the ROI. In other examples as discussed in relation to FIGS. 2C and 2D in which the images do not contain faces, the ROI is determined by other methods. It should also be noted that although child element 14 contains a single ROI there may be multiple ROIs in a single image. In some cases, one or more of the multiple ROIs can be treated as different child elements or they can provide additional crop options that include various subsets of the ROIs. In another example, face recognition software may determine the ROI according to the identities of individuals in one or more of the images.

Multiple ROIs may be nested such that they indicate progressive degrees of cropping. Similarly in the case of child elements that are themselves layouts of grandchildren, ROIs may encapsulate a progressive reveal operation for an element for example that reveals a blog update at its tightest constraint, and progressively exposes comments on that update as the constraints are relaxed. The term ROI refers to the general concept of a restricted portion of the content of a child regardless of whether the child is an image or other content type. The term crop refers to the selection of a restricted portion of the content of a child element.

If the ROI for an element has already been determined, step 24 may simply involve retrieval of information relating to the predetermined ROI, for example by retrieving ROI metadata associated with the image.

At step 28, a permissible range of internal layouts is determined dependent on the content of the child element 14. In this embodiment, the permissible range extends between the full image and the minimum width and height of the image which contains the ROI 16. The permissible variables for cropping the image are a vertical range extending between the horizontal internal layout lines 28 (shown in broken lines) and the horizontal edges of the image (shown in bold lines) and a horizontal range extending between the vertical internal layout lines 30 (shown in broken lines) and the vertical edges of the image (shown in bold lines). Step 28 provides a plurality of different rectangular crops of varying size and aspect ratio within the permissible values of the internal layout. The permissible values of the internal layout are not restricting to a range of rectangular crops and can be any other shape as required, such as curvilinear, polygonal or irregular. However, rectangular crops are discussed herein for simplicity.

At step 32, it is determined if all child elements required for populating a space have been retrieved from store 20. If NO is returned, the method steps 22, 24 and 28 are repeated.

A second child element 34 is shown in FIG. 2B. Child element 34 differs from child element 14 in that three faces 36 are contained in the image. In repeated step 22, child element 34 is retrieved from the store 20 and an ROI for the element is determined at step 24 containing all three faces. At step 28, the permissible range, or values for the internal layout of the child element are calculated. Similarly to the internal layout of child element 14, the permissible internal layouts are rectangular crops of varying size and aspect ratio defined between layout lines 38, 40 and the edges of the image. In an alternative, the ROI of child element 34 could be three discrete ROIs each containing a single face. In this case, each ROI can be treated separately.

Third and fourth child elements 42, 43 are shown in FIG. 2C and 2D. These elements do not contain faces and instead contain other imagery such as a building, landscape or a sporting event. These types of images can be sampled for example by analyzing the contrast or brightness between different regions of the image or isolating the foreground from the background. The ROIs are shown schematically as rectangular blocks and in FIG. 20 the ROI 44 has a greater vertical extent and in FIG. 20 the ROI 46 has a greater horizontal extent. Once the ROIs have been determined at step 24, the permissible values for the internal layout are determined at step 28 in a similar way to that described in relation to FIGS. 2A and 2B. The resulting permissible values are defined as rectangular crops of variable size and aspect ratio between layout lines 48, 50 and the edges of the images.

FIG. 1 is a flowchart illustrating a method of populating a space, in accordance with one embodiment of the present invention. The method is carried out by processors and electrical components under the control of computer readable and computer executable instructions stored on a computer-usable storage medium. The computer readable and computer executable instructions reside, for example, in data storage features such as computer usable volatile and non-volatile memory. The computer usable medium may be non-transitory. However, the computer readable and computer executable instructions may reside in any type of computer-usable storage medium.

A space 10 is shown in FIGS. 1, 3 and 4 for population with child elements 14, 34, 42, 43 shown in FIGS. 2A to 20. The space can be populated with child elements in numerous different ways and in the present embodiment it is populated based on a columnar layout. Alternatively, the layout could be based on rows or grids or any other required basis. The term ‘external layout’ used herein refers to the layout of the space and is to be differentiated from ‘internal layout’ which is the layout of the child element, as discussed in detail above. The space shown is a single page but this is by no means the only possible space.

The columnar layout of the space comprises constraints on the population of the page. The constraints in FIGS. 3 and 4 are top horizontal margin 52, bottom horizontal margin 54, and vertical side margins 56, 58. The columnar layout requires that child elements populate the space in columns and three columns are shown in FIGS. 3 and 4. First and second columns are separated by a central vertical layout line 60 and a wider column spans the width of both columns. These external layout lines are shown in broken lines. Although three columns are shown any suitable number of columns can be selected by a columnar layout engine depending on the child elements. For example, a best layout of the child elements may be returned if there are two vertical dividing lines. For purposes of simplicity however the description will discuss a single dividing line.

At step 62, the external layout variables or constraints are retrieved from a layout engine 61 for the space 10. A first set of allocations 64a, 64b, . . . , 64n of the child elements are generated for allocating the child elements to the space. Each first allocation is a layout of child elements which occupies less than the total amount of space to be populated. One first allocation of child elements is shown in FIG. 3. Multiple different first allocations are generated depending on for example on the number of child elements to be fitted in the space, the layout order of the child elements, the differing emphasis requirements of the child elements and the external layout constraints of the space. However, the first allocations do not occupy the total available space and therefore the number of possible first allocations is increased compared with a technique which attempts to fill the space in an initial (single) allocation. As the number of first allocations is increased the number of second allocations is increased and therefore there are a greater number of second allocations to be ranked for the best layout. Generation of the second allocations is described in more detail below.

In the embodiment described, in each of the first allocations 64a, 64b, . . . , 64n the child elements comply with the external layout constraints such as requiring child elements to have a width that spans exactly an integer number of columns, and the child elements occupy a minimum amount of space within the permissible range of internal layouts. Minimizing the space allocated to the child elements maximizes the number of possible first allocations available. With reference to FIG. 3, the columnar layout imposes the constraint that any element must be laid out to span exactly one or two columns. More than two columns can be specified as indicated above. In the first allocation 64a, the first child element 14 is allocated to a column so that it spans the width between the central vertical line 60 and the left vertical margin 56. Typically the child element 14 will not be cropped in the horizontal dimension and is therefore bounded by the vertical edges of the image shown in FIG. 2A to give the widest possible aspect ratio. Therefore, the child element occupies the maximum horizontal value of its internal layout. The child element 14 is cropped in the vertical dimension so that it is bounded by the internal layout lines 28. Therefore, the child element occupies the minimum vertical value of its internal layout. In order to aid understanding of the present embodiment, that part of the background 18 that has not been cropped is visible in FIG. 3.

Whilst maximised cropping is shown in FIG. 3, embodiments of the invention would still benefit if the child elements are cropped to less than the maximum crop. Likewise, child elements can be cropped to a certain extent in the horizontal dimension in the first a location.

The child elements 34, 42 and 43 are allocated in the first allocation 64a in the same way as child element 14 is allocated. Therefore, second child element is bound by its internal horizontal lines 38 and spans exactly one column between central line 60 and left margin 56. The third child element 42 spans exactly two columns between left and right margins 56, 58 and is bound by its internal horizontal lines 48, 48. The fourth child element 43 spans the width of the column between the central line 60 and the right margin 58 and is bound by its internal horizontal lines 48, 48.

The first allocation 64a occupies less than the total space available and leaves blank spaces 66 which are not occupied by child elements. It will be appreciated that multiple alternative layouts of the elements is possible in additional first allocations 64b to 64n, for example, the child elements 14, 34 could be arranged side-by-side with element 14 on the left, side-by-side with the element 34 of the left, or one above the other with each spanning two columns.

At the next stage of the process, the system generates a second set of allocations 68a, 68b, 68n of the child elements by expanding the child elements allocated in each of the first allocations within the permissible range of internal layouts of the child elements such that the child elements occupy a greater amount of space in the second allocation than the first allocation. The second allocation 68a corresponding to first allocation 64a is shown in FIG. 4. In the embodiment, substantially all of the space available for population is allocated to a child element 14, 34, 42, 43, that is, the region available within the external layout of the space 10, which in this case is defined by the margins 52, 54, 56, 58.

The purpose of the second allocations is to expand the child elements (to relax the constraints to reveal more of the original image) from their allocations in respective first allocations so that more of the available region of the space is occupied than in the first allocation, In the embodiment, the child elements are constrained in one dimension so that they comply with at least one variable of the external layout. Therefore, in the second allocation, the child elements are expanded in one or more different dimensions so that they comply more closely with one or more other variables of the external layout. In FIG. 4, the child elements have been expanded in the vertical dimension, since the first allocation ensured that the elements complied with the orthogonal and horizontal variables of the external layout. Therefore, the second allocation expands the crop of an element by decreasing the aspect ratio of width to height. In the alternative arrangement of an external layout based on rows, the expansion step would increase the aspect ratio. In a further alternative arrangement in which the external layout is based on a grid the expansion step may increase both the height and the width. In this regard, a grid layout may require that each element fills exactly an integer number of the grid rectangles, and all the elements could initially be such that they fill exactly one grid rectangle. Then expansion could proceed by expanding both the width and the height of each element until the grid is filled.

Each element may be expanded by a different amount with the object of filling the available space. As shown in FIG. 4, each element is expanded in the vertical direction so that the final upper and lower vertical limits 70, 72 are between the internal horizontal layout lines and the edge of the image (as shown in FIGS. 2A to 2D). It will be seen that element 14 has been expanded so that the background 18 is now visible. The elements can be expanded to achieve one or more different or alternative objectives. For example, the expansion can be restricted so that the subject-matter, or ROIs, of different images are in proportion (e.g. the faces in two elements are similar in size). Alternatively, one or more of the elements can be given more prominence in the layout, perhaps if it is the principle subject-matter of the layout. The weight given to the elements can be in response to a user supplied input. In a further alternative, a plurality of second allocations can be generated from each corresponding first allocation by expanding the elements by different respective amounts in the second allocations.

In a modification, the external layout may define a space between columns which is to be left blank in a final display. If there are multiple elements overlapping a particular column of the minimised layout, the expansion process should find an appropriate way to share out the adjustments to the aspect ratios of the individual elements. For example if the two images in your first figure where laid out one above the other, one or both could be expanded to fill the available height. One strategy might be to expand the two elements in such a manner as to equalize the percentage of the total original area cropped from each. Another strategy might be to expand them to equalise the total facial area of each image, or even to minimize the facial scale difference between the two images.

At step 74 of FIG. 1, the second allocations 68a, 68b, . . . , 68n are ranked to determine a layout to be returned to the user at step 76. As indicated above, the final layout has one or more desired characteristics and the second allocations are ranked dependent on their compliance with the desired characteristics, or how well they satisfy the desired characteristics. In the illustrated embodiment, the desired characteristic is to fill the space available for population. Therefore, the ranking algorithm may simply calculate the space filled by each of the second allocations as a percentage of the available space and return the layout with the highest percentage. If the desired characteristic is to match face proportionality, the ranking algorithm may compare the space occupied by the faces of the child elements and return the layout with the lowest difference. Other characteristics may be desirable and the second allocations may be ranked dependent on more than one characteristic. The selected characteristic may be dependent on a user supplied selection.

Although it is generally appropriate to return the best ranked layout to the user in the first instance as the best ranked layout has the highest probability of satisfying the user's requirements, the system allows the user to reject a returned layout and to request another layout. In this case, the system will return another layout based on a different second allocation. This arrangement is useful because a user's requirements are to some degree subjective and the mathematically best layout may not meet the user's subjective requirements.

It will be appreciated from the foregoing that the illustrated embodiment comprises a two stage allocation process. A first allocation maximally constrains a child element, for example so that each child takes the least possible area of the space available for population. However, the first allocation will typically not meet the required design criteria, leaving unsightly blank white spaces.

The second stage allocation is a step in which the constraints on the child elements are relaxed within the range defined by its determined internal layout until the external layout requirements are optimally addressed. For example, the child elements may be allowed increasing area to meet coverage requirements, or alternatively the child elements may be sized differently to meet aesthetic balance requirements.

The embodiment is advantageous because a space can be populated in many different ways and child elements can be displayed in many different ways. Determining the location and dimensions of a child element in the space is computationally complex and the embodiment simplifies the computation while the expansion step increases the potential of generating a pleasing display. In the case of a columnar layout, the first allocation of child elements arranges each element so that it completely fills a column. Allowing an element to completely fill a column removes one variable from the calculation in that width is always maximised within the constraints of the layout engine. The first allocation minimises element height allowing a greater number of possible first allocations that are feasible. The second allocation finds optimal crops of the element within the constraints of the layout engine and the available space without having to re-evaluate alternative relative locations for all the child elements.

1. A method of populating a space with a plurality of child elements at least one of which having variable size or shape, the method comprising: determining for each child element a permissible range of internal layouts dependent on the content of the child element; generating a first set of allocations of the child elements in the space, each first allocation being a layout of child elements which occupies less than the total amount of space to be populated; generating a second set of allocations of the child elements by expanding the child elements allocated in each of the first allocations within the permissible range of internal layouts of the child elements such that at least some of the child elements occupy a greater amount of space in the second allocation than the first allocation.

2. A method as claimed in claim 1, wherein the child elements are allocated to comply with at least one constraint of the external layout of the space in each of the first allocations.

3. A method as claimed in claim 1, wherein the child elements are sized to comply with the constraint of the external layout of the space in a first dimension in each of the first allocations.

4. A method as claimed in claim 3, wherein the child elements are cropped in at least a second dimension different from the first dimension within the determined permissible range to reduce the amount of space occupied by the child elements in the first allocations.

5. A method as claimed in claim 4, wherein the child elements are cropped in at least the second dimension to a maximum extent within the determined permissible range.

6. A method as claimed in claims 4, wherein the child elements of the first allocations are expanded in at least the second dimension in the corresponding second allocation.

7. A method as claimed in claim 6, wherein the child elements are expanded in at least the second dimension to the maximum allowable within the constraints of the external layout.

8. A method as claimed in claim 1, wherein the second allocations are ranked according to the second allocations compliance with one or more selected layout characteristics of the space.

9. A method as claimed in claim 8, wherein the selected layout characteristic is the amount of the space occupied by the child elements in the second allocations.

10. A method as claimed in claim 1, wherein the permissible range of internal layouts for each child element is determined by locating in the child element one or more regions of interest and determining the range of crops of the child element that retain at least one of the regions of interest.

11. A computer usable storage medium having instructions embodied therein that when executed cause a computer system to perform a method of populating a space with a plurality of child elements having variable size or shape, the method comprising: determining for each child element a permissible range of internal layouts dependent on the content of the child element; generating a first set of allocations of the child elements in the space, each first allocation being a layout of child elements which occupies less than the total amount of space to be populated; generating a second set of allocations of the child elements by expanding the child elements allocated in each of the first allocations within the permissible range of internal layouts of the child elements such that the child elements occupy a greater amount of space in the second allocation than the first allocation.

12. A computer usable storage medium as claimed in claim 11, wherein the child elements are allocated to comply with at least one constraint of the external layout of the space in each of the first allocations.

13. A computer usable storage medium as claimed in claim 11, wherein the child elements are sized to comply with the constraint of the external layout of the space in a first dimension in each of the first allocations.

14. A computer usable storage medium as claimed in claim 13, wherein the child elements are cropped in at least a second dimension different from the first dimension within the determined permissible range to reduce the amount of space occupied by the child elements in the first allocations.

15. A computer usable storage medium as claimed in claim 14, wherein the child elements are cropped in at least the second dimension to a maximum extent within the determined permissible range.

16. A computer usable storage medium as claimed in claims 14, wherein the child elements of the first allocations are expanded in at least the second dimension in the corresponding second allocation.

17. A computer usable storage medium as claimed in claim 16, wherein the child elements are expanded in at least the second dimension to the maximum allowable within the constraints of the external layout.

18. A computer usable storage medium as claimed claim 11, wherein the second allocations are ranked according to the second allocations compliance with one or more selected layout characteristics of the space.

19. A computer usable storage medium as claimed in claim 18, wherein the selected layout characteristic is the amount of the space occupied by the child elements in the second allocations.

20. A computer usable storage medium as claimed in claim 11, wherein the permissible range of internal layouts for each child element is determined by locating in the child element one or more regions of interest and determining the range of crops of the child element that retain at least one of the regions of interest.
